(19) United States
(12) Patent Application Publication
(10) Pub. No.: US 2017/0116291 A1
(43) Pub. Date: Apr. 27, 2017

(54) NETWORK CACHING OF SEARCH RESULT HISTORY AND INTERACTIONS

(71) Applicant: Adobe Systems Incorporated, San Jose, CA (US)

(72) Inventors: Neelabh Sunny, Budaun (IN); Dheeraj Agrawal, Jaipur (IN)

(73) Assignee: Adobe Systems Incorporated, San Jose, CA (US)

(21) Appl. No.: 14/923,671

(22) Filed: Oct. 27, 2015

(51) Int. Cl. G06F 17/30; H04L 29/08

(52) U.S. Cl. CPC G06F 17/30554; H04L 67/10

(57) ABSTRACT

Improved search result management techniques enable a user to cache a his/her interactions with a listing of search results. A search index lists, for one or more files, previously-executed search queries and n most recently selected search results associated with each search query. In one embodiment, n=3. If a search query that is listed in the search index is re-executed, the n most recently selected search results are presented to the user along with a comprehensive listing of search results. If one of the search results is selected, the search index is updated, if appropriate, to reflect the selected search result as being the most recently selected search result. In certain embodiments, the search index is maintained at a cloud-based storage resource, thus allowing the user to leverage the search result interaction history without regard to whether the previously executed search was performed using a different device.

### FIELD OF THE DISCLOSURE

This disclosure relates generally to tools that can be used to search for information stored on a computer system, and more specifically to techniques for caching a user's interactions with a listing of search results.

### BACKGROUND

Mobile applications and cloud-based storage resources provide consumers with a distributed computing environment that makes it easy for them to work when and where they please. Consumers with access to a distributed computing environment often use multiple devices to complete their tasks. For example, a user may interrupt the drafting of an email message to attend an offsite meeting, but may resume drafting the message using a smartphone while riding the subway back to the office after the meeting. Consumers working in a distributed computing environment also often shift their focus amongst multiple tasks, thus subjecting their work to more frequent interruptions. For example, while drafting the email on the subway, the user may receive a phone call that diverts his/her attention from the email for several minutes. While the ability to use multiple devices and multitask may provide greater convenience for the user, it can also adversely affect the user's efficiency. In particular, each time a user switches between devices, or shifts attention from one task to another, the user often needs a few moments to refocus on the task at hand and “pick up where he/she left off”. In general, while many existing software applications are well-suited for creating a distributed work environment where it is easy to work remotely and multitask, few applications have been adapted to make the process of shifting between devices and/or tasks more efficient. Existing software applications also make it difficult or impossible for a user to leverage his/her interaction history with the various features provided by the application. Providing a system that reduces this burden represents a substantial challenge in the field of distributed computing.

### BRIEF DESCRIPTION OF THE DRAWINGS

FIG. 1 is a block diagram illustrating selected components of an example client-server computing environment that can be used to cache a user's interactions with a listing of search results.

FIGS. 2A and 2B comprise a flowchart illustrating an example method of caching a user's interactions with a listing of search results.

FIG. 3 is a screenshot illustrating an example user interface that displays both a comprehensive listing of search results, as well as a focused list of the most recently selected search results from amongst those included in the comprehensive listing.

FIG. 4 is a data flow diagram schematically illustrating the use of cloud storage to facilitate the propagation of search query result interaction data from a desktop computer to a smartphone, as may be implemented in certain of the embodiments disclosed herein.

### DETAILED DESCRIPTION

One scenario in which shifting between devices and/or tasks is particularly inefficient is in the review of a listing of search results. Software applications such as word processors, spreadsheet programs, electronic mail readers, web browsers, and document readers are often used to find instances of a specific term or phrase located within a larger corpus of text. The larger corpus of text may be a single file or an index containing text extracted from many files, such as an electronic mail index or other search index. A particular search may produce a listing of search results that comprises tens, hundreds, or more instances of the search term or phrase. Depending on how the search is performed, the listing of search results may not be sequenced in a consistent manner, or in a way that makes sense to the user. In particular, the appearance of the displayed search results is independent of the user's past interaction with the same search results. Reviewing large quantities of search results can be a time consuming process. If, after the reviewing some of the search results the user needs to re-execute the search, for example because he/she has moved to a different device, or was briefly interrupted by a different task, there is no easy way for the user to see which search result instances have already been interacted with, and which have not.

For example, if a user searches Charles Dickens's A Tale of Two Cities for the query “London”, 28 sequential instances of the queried term will result. The user may select and review 15 instances of “London” before finding the instance of interest. If, several days later, the user performs the same query, the same sequence of query results will be produced. The user will once again have to navigate through multiple instances of “London” before finding the instance of interest. Disclosed herein is, among other things, a systemic approach to displaying optimized search results, and storing search history using a cloud-based storage resource, thus resulting in increased efficiency.

Thus, in accordance with certain of the embodiments disclosed herein, improved search result management techniques enable a user to cache his/her interactions with a listing of search results. A search index lists, for one or more files, previously-executed search queries and n most recently selected search results associated with each search query. In one embodiment, n=3. If a search query that is listed in the search index is re-executed, the n most recently selected search results are presented to the user along with a comprehensive listing of search results. If one of the search results is selected, the search index is updated, if appropriate, to reflect the selected search result as being the most recently selected search result. In certain embodiments, the search index is maintained at a cloud-based storage resource, thus allowing the user to leverage the search result interaction history without regard to whether the previously executed search was performed using a different device. Numerous configurations and modifications will be apparent in light of this disclosure.

Certain of the embodiments disclosed herein make it easy for a user to maintain a record of his/her interaction history with a particular set of search results. This interaction history can be accessed from multiple devices, and therefore search result interactions that occur on one device can be reflected when the same search is later executed on a second device. While such embodiments allow a user working in a distributed computing environment to more efficiently switch between devices and/or tasks, the advantages are limited to neither mobile nor multitasking users. For example, when a user working at a desktop computer in his/her office executes a search, certain embodiments will enable the user to see which of the search result instances he/she has previously interacted with, since these instances are once again likely to be of particular interest to the user. This is especially advantageous when working with large files which are likely to produce large quantities of search result instances. Because the user's search result interaction history can be maintained in cloud storage, in certain implementations simply logging into the user's cloud storage account will enable the features disclosed herein. Thus it will be appreciated that certain embodiments provide users with a better understanding of how they have previously interacted with the results of a particular search query. These and other advantages will be apparent in view of the disclosure provided herein.

As used herein, the term “search query” refers, in addition to its ordinary meaning, to a string of characters that is the subject of a search operation within a corpus of searched text. A search query may comprise one word or multiple words, and may include letters, numbers, punctuation symbols, formatting instructions, metadata that may not necessarily be visible to a user, and any combination of the foregoing. A search query may also include Boolean or other logical operators. A search query is also sometimes referred to as a “keyword”, despite the fact that the query may include more than one word, metadata, and/or other latent terms. A search query may be submitted or otherwise executed, using a “Find” or “Search” command of a software application that is used to display or otherwise interact with the corpus of searched text. If the corpus of searched text contains the characters that define search query, executing the search query will produce a listing of search results that comprises one or more instances of the search query within the corpus of searched text. In some cases a user may interact with a listing of search results, for example by selecting and/or viewing a particular instance of the search query that is listed in the search results. Data characterizing such interactions may be referred to as “search query result interaction data”.

As used herein, the term “cloud-based storage” refers, in addition to its ordinary meaning, to a computing device or resource that provides data storage in a distributed network of storage devices rather than on one specific device. However, notwithstanding the fact that it comprises a large number of distributed resources, cloud-based storage acts as—and therefore can be interacted with as—a single storage device. The data stored in cloud-based storage can be logically organized into a plurality of “data records” which may, for example, correspond to individual files, objects, or other logical containers. Cloud-based storage is typically owned and administered by a host that is responsible for keeping data available and accessible, although larger organizational users may build and administer their own cloud-based storage. Regardless of the particular administrative model implemented, users access the services provided by cloud-based storage via an application programming interface (API) or via applications that use the API, such as a cloud storage desktop application, a cloud sever gateway, or a web-based content management system. In many cases the same host that manages the cloud-based storage also provides the API or user interface through which the storage resources can be leveraged. Cloud-based storage is therefore often understood as being implemented in a client-server computing environment, wherein the cloud-based storage is provided by a server and the local computing device acts as a client.

As used herein, the term “file” refers, in addition to its ordinary meaning, to any collection of digital information that can be communicated between the various systems and devices disclosed herein. A file can be embodied in a non-transitory computer readable medium containing digital data. Files can be read and processed by a wide range of software applications, including but not limited to, word processors, spreadsheet programs, electronic mail readers, web browsers, and document readers. The digital information that is collected in a file is often referred to as “content”, and thus a software application that is configured to read, render, or otherwise process such content may be referred to as a “content consumption application”. Files can be rendered in a variety of different ways, such as via display on a screen, by printing using an output device, or aurally using an audio player and/or text-to-speech software. Thus, it will be appreciated that files may include digital assets in addition to or instead of text, including for example, audio clips, video clips, photographs, and other multimedia assets. A “file” may also sometimes be referred to as an “electronic file”, a “document”, or an “electronic document”.

As used herein, the term “data structure” refers, in addition to its ordinary meaning, to a way of storing and organizing data in a computer accessible memory so that data can be used by an application or software module. In its simplest from, a data structure can be, for example, a set of one or more memory locations. In some cases a data structure may be implemented as a so-called record, sometimes referred to as a struct or tuple, and may have any appropriate number of fields, elements, or storage locations. As will be further appreciated, a data structure may include data of interest or a pointer that refers to a memory location where the data of interest can be found. A data structure may have any appropriate format such as, for example, a lookup table or index format; an array format; a hash table format; a graph, tree, or hierarchical format having a number of nodes; an object format that includes data fields; or a combination of the foregoing. A data structure many include executable code for accessing and modifying the underlying structure and format of the data stored therein. In a more general sense, the data structure may be implemented as a data set that can store specific values without being constrained to any particular order or format. In one embodiment, a data structure comprises a hierarchical tree listing files, search queries performed on those files, and particular recently selected instances of the search queries. Nemours other data structure formats and applications will be apparent in light of this disclosure.

System Architecture

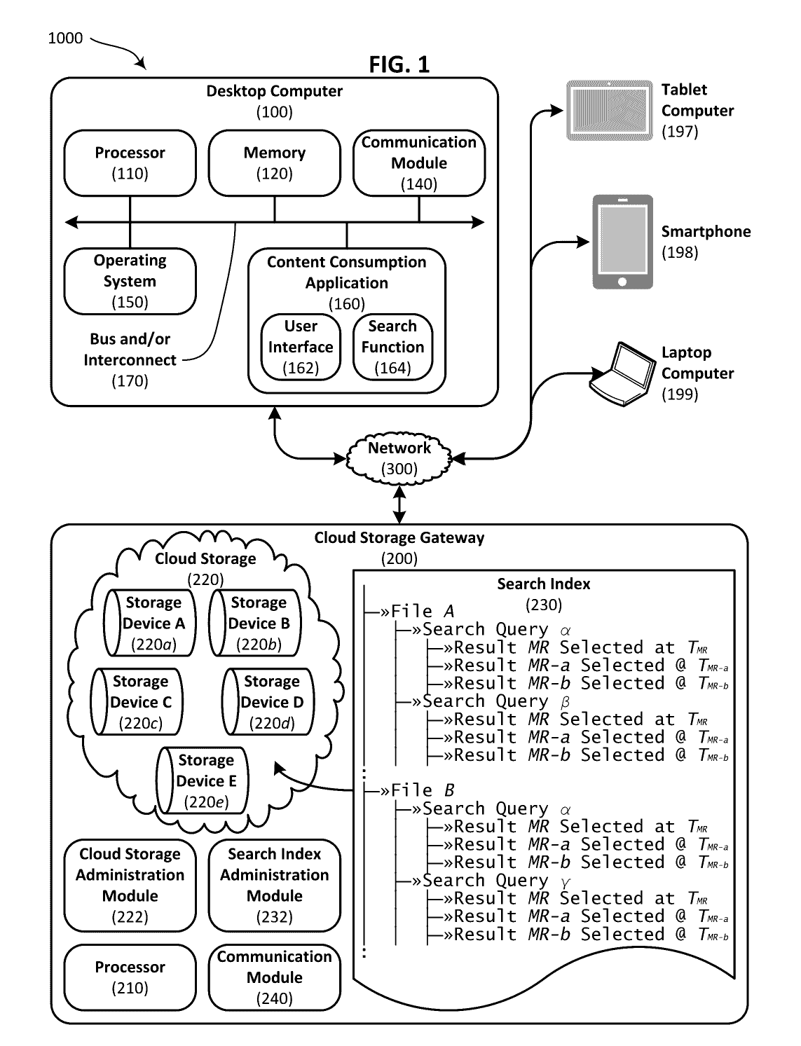

FIG. 1 is a block diagram illustrating selected components of an example client-server computing environment 1000 that can be used to cache a user's interactions with a listing of search results. For example, in one embodiment, search query result interaction data that characterizes a user's interactions with a listing of search results is stored in cloud storage 220. Cloud storage 220 is managed by a cloud storage gateway 200, which functions as the server in client-server computing environment 1000. The user can access and modify this search query result interaction data using a variety of different client devices, such as a desktop computer 100, a tablet computer 197, a smartphone 198, and/or a laptop computer 199. The client devices and cloud storage gateway 200 communicate with each other via a network 300. Other embodiments may have fewer or more communication paths, networks, subcomponents, and/or resources depending on the granularity of implementation. For example, while one cloud storage gateway and four client devices are illustrated in FIG. 1 for purposes of clarity, it will be appreciated that, in general, tens, hundreds, thousands, or more cloud storage gateways can be configured to service requests received from an even larger number of client devices. Thus the embodiments described and illustrated herein are not intended to be limited to the provision or exclusion of any particular services and/or resources.

As noted above, the client devices that are included in client-server computing environment 1000 may comprise, for example, one or more devices selected from desktop computer 100, tablet computer 197, smartphone 198, laptop computer 199, a workstation, a set-top box, or any other suitable computing device. A combination of different devices may be used in certain embodiments. As illustrated in the example embodiment of FIG. 1, desktop computer 100 includes one or more software modules configured to implement certain of the functionalities disclosed herein, as well as hardware capable of enabling such implementation. The hardware may include, but is not limited to, a processor 110, a memory 120, and a communication module 140. A bus and/or interconnect 170 is also provided to allow for inter- and intra-device communications using, for example communication module 140. The hardware may also include integrated or peripheral input/output components such as one or more of a tactile keyboard, a display, a touch sensitive display, a microphone, a camera, and any other suitable components that enable a user to control the operation of desktop computer 100. The implementing software, on the other hand, may include components such as an operating system 150 and a content consumption application 160. Other components and functionality not reflected in the schematic block diagram of FIG. 1 will be apparent in light of this disclosure, and it will therefore be appreciated that the present disclosure is not intended to be limited to any particular configuration of hardware and/or software. Furthermore, while only desktop computer 100 is illustrated as comprising the aforementioned software modules and hardware components, it will also be appreciated that other client devices, such as tablet computer 197, smartphone 198, and laptop computer 199 may contain the same or similar software modules and hardware components. A single user may therefore connect to cloud storage gateway 200 using a variety of different client devices.

Referring to the hardware components that comprise the example desktop computer 100 illustrated in FIG. 1, processor 110 can be any suitable processor, and may include one or more coprocessors or controllers, such as an audio processor or a graphics processing unit, to assist in processing operations of desktop computer 100. Memory 120 can be implemented using any suitable type of digital storage, such as one or more of a disk drive, a universal serial bus drive, flash memory, and/or random access memory. In one embodiment memory 120 stores a local file system capable of storing a large quantity of files that are organized in a hierarchical manner. Communication module 140 can be any appropriate chip or chipset which allows for wired and/or wireless communication via network 300 to one or more of the other components described herein.

In terms of the software components that comprise desktop computer 100, operating system 150 may comprise any suitable operating system, such as Google Android (Google Inc., Mountain View, Calif.), Microsoft Windows (Microsoft Corporation, Redmond, Wash.), or Apple OS X (Apple Inc., Cupertino, Calif.). As will be appreciated in light of this disclosure, the techniques described herein can be implemented without regard to the particular operating system provided in conjunction with desktop computer 100, and therefore may also be implemented using any suitable existing or subsequently developed platform. The implementing software may also include content consumption application 160, which can be configured to provide a user interface 162 that facilitates interaction with the content contained in a file, such as a file stored in memory 120 or a file stored in cloud storage 220. For example, in certain embodiments content consumption application 160 includes one or more of a word processor, a spreadsheet program, an electronic mail reader, a web browser, a document reader, a database interface, a digital image editing application, a drawing application, a multimedia player, and a document management system. Content consumption application 160 includes a search function 164, such as a “Find” command, that allows a user to search for a particular keyword within a file. Desktop computer 100 may be configured to implement a wide range of other content consumption functionality in other embodiments, including content consumption functionality which is remotely provisioned via network 300.

Referring still to the example client-server computing environment 1000 illustrated in FIG. 1, cloud storage gateway 200 includes cloud storage 220 as well as a cloud storage administration module 222 that is configured to administer the operations of cloud storage 220. Cloud storage 220 comprises hardware that is used to store the data that is managed by cloud storage gateway 200. Such data may include (a) files containing content that is searched using a search query, as well as (b) a file containing a search index 230 which in turn contains search query result interaction data that characterizes a user's interaction with search results that are generated upon execution of a search query. In one embodiment, cloud storage 220 comprises a plurality of storage devices 220a, 220b, 220c, 220d, 220e that are optionally distributed geographically, and that use any suitable technology for storing large quantities of digital data. Examples of such technologies include file servers that use semiconductor storage technology (such as dynamic random access memory or flash memory), magnetic hard disc storage technology, and/or optical disc storage technology. As will be appreciated in light of this disclosure, the techniques described herein can be implemented without regard to the particular storage technology used to implement cloud storage 220, and therefore may also be implemented using any suitable existing or subsequently developed storage technology. Likewise, while only five storage devices are illustrated in FIG. 1, in general cloud storage 220 will often comprise tens, hundreds, thousands, or more storage devices. Many cloud-based storage resources introduce a degree of redundancy into the data storage scheme, and thus a given data record may be stored on a plurality of the storage devices.

Cloud storage administration module 222 comprises instructions encoded on a computer readable medium that, when executed using a processor, cause one or more of a variety of different cloud storage administration processes to be carried out. One such cloud storage administration process involves managing client interactions with cloud storage 220, including authenticating and responding to file operations, managing file version control, and performing data synchronization and replication operations. Another example cloud storage administration process involves providing load balancing functionality amongst the plurality of storage devices that comprise cloud storage 220.

As noted above, cloud storage 220 can be used to store a file containing search index 230. In one embodiment search index 230 is a data structure that contains search query result interaction data that characterizes a user's interaction with search results that are generated upon execution of a search query. Because different users will work with different files, execute different search queries, and interact with different search results, it should be appreciated that the data contained in search index 230 is unique to a particular user. Thus cloud storage 220 can be understood as comprising a plurality of different search indices for a corresponding plurality of different users. For clarity only one search index is illustrated in FIG. 1. In an alternative embodiment, a single search index is stored in cloud storage, wherein an upper level of a hierarchical data structure that forms the single search index indicates different users whose search query result interaction data is stored in the search index.

Still referring to the example embodiment illustrated in FIG. 1, in one implementation search index 230 comprises a hierarchical data structure. Files having content which has been searched—for example using search function 164 of content consumption application 160—are indicated in an upper level of the hierarchical data structure. See, for example, File A, File B, and so forth in FIG. 1. For each file, one or more search queries are indicated in an intermediate level of the hierarchical data structure. Collectively, the upper and intermediate levels of search index 230 therefore indicate the search queries that a particular user has performed on a particular file. For example, the user associated with the example search index 230 illustrated in FIG. 1 has executed Search Query α and Search Query β on the content of File A, and has also executed Search Query α and Search Query γ on the content File B.

For each search query, a plurality of recently selected search result instances are indicated in a lower level of the hierarchical data structure corresponding to search index 130. For example, after the user executed Search Query α on File A, the user selected most-recent search result instance MR at most-recent time Tₘ; selected second-most-recent search result instance MR-a at second-most-recent time Tₘ₋ₐ; and selected third-most-recent search result instance MR-b at third-most-recent time T_{m-b}. The lower level of the hierarchical data structure therefore provides an indication of the most recently selected search result instances for the various searches executed by the user associated with the example search index 230. While the three most recently selected search result instances are illustrated as being included in search index 230 illustrated in FIG. 1, it will be appreciated that in other implementations more or fewer than three search result instances may be indicated, particularly where the user has selected fewer than three search result instances after executing the search query for the first time.

In certain embodiments cloud storage gateway 200 includes a search index administration module 232 configured to maintain one or more search indices 230 that are kept in cloud storage 220. Search index administration module 232 comprises instructions encoded on a computer readable medium that, when executed using a processor, cause one or more of a variety of different search index administration processes to be carried out. One such search index administration process involves responding to a search executed using search function 164 and, in particular, responding to user interactions with a listing of search results generated by such search. This may include adding and/or removing recently selected search result instances that are indicated in a lower level of the hierarchical data structure that forms search index 230. In an alternative embodiment, search index administration module 232 is omitted, in which case its functionality is instead provided by a similar module executing at client device. Such a client-side search index administration module can likewise be configured to invoke one or more search index administration processes that respond to user interactions with a listing of search results, and subsequently send updated search query result interaction data to cloud storage gateway 200 for inclusion in search index 230. Thus it should be appreciated that the functionality associated with search index administration module 232 can be implemented on the client side and/or on the server side of client-server computing environment 1000.

As illustrated in FIG. 1, in an example embodiment cloud storage gateway includes additional hardware capable of implementing the various functionalities disclosed herein, including a processor 210 and a communication module 240. Processor 210 can be any suitable processor, and may include one or more coprocessors or controllers, such as an audio processor or a graphics processing unit, to assist in processing operations of cloud storage gateway 200. Communication module 240 can be any appropriate chip or chipset which allows for wired and/or wireless communication via network 300 to one or more of the other components described herein.

The embodiments disclosed herein can be implemented in various forms of hardware, software, firmware, and/or special purpose processors. For example, in one embodiment a non-transitory computer readable medium has instructions encoded therein that, when executed by one or more processors, cause one or more of the methods for caching a user's interactions with a listing of search results, as disclosed herein, to be implemented. The instructions can be encoded using any suitable programming language, such as C, C++, object-oriented C, Swift, JavaScript, Java, Visual Basic .NET, BASIC, or alternatively, using custom or proprietary instruction sets. Such instructions can be provided in the form of one or more computer software applications and/or applets that are tangibly embodied on a memory device, and that can executed by a computer having any suitable architecture. In one embodiment the system can be hosted on a given website and implemented, for example, using JavaScript or another suitable browser-based technology.

The functionalities disclosed herein can be incorporated into a wide range of software applications, such as a word processor, a spreadsheet program, an electronic mail reader, a web browser, a document reader, a database interface, a digital image editing application, a drawing application, a multimedia player, or a document management system. For example, an application configured to view portable document format (PDF) files can be configured to implement certain of the functionalities disclosed herein in response to a user command to search for a particular keyword in a viewed PDF file. The computer software applications disclosed herein may include any number of different modules, sub-modules, or other components of distinct functionality, and can provide information to, or receive information from, still other components and/or subcomponents. These modules can be used, for example, to communicate with an input and/or output device such as a display screen, a touch sensitive surface, a printer, and/or any other suitable input/output device. Other components and functionality not reflected in the illustrations will be apparent in light of this disclosure, and it will be appreciated that the various embodiments described herein are not limited to any particular hardware or software configuration. Thus in other embodiments desktop computer 100 and cloud storage gateway 200 may each comprise additional, fewer, or alternative subcomponents as compared to those included in the illustrated embodiments.

The aforementioned non-transitory computer readable medium may be any suitable medium for storing digital information, such as a hard drive, a server, a flash memory, and/or random access memory. In alternative embodiments, the computer and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used in this regard, and that the present disclosure is not intended to be limited to any particular system architecture.

Methodology

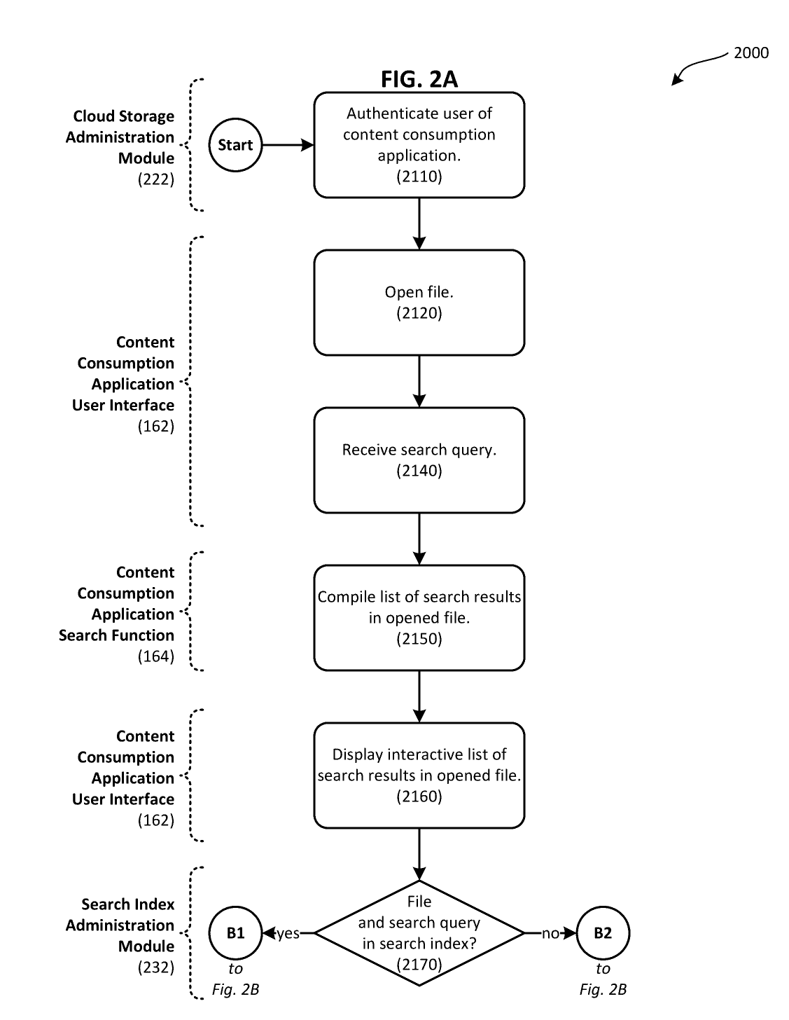

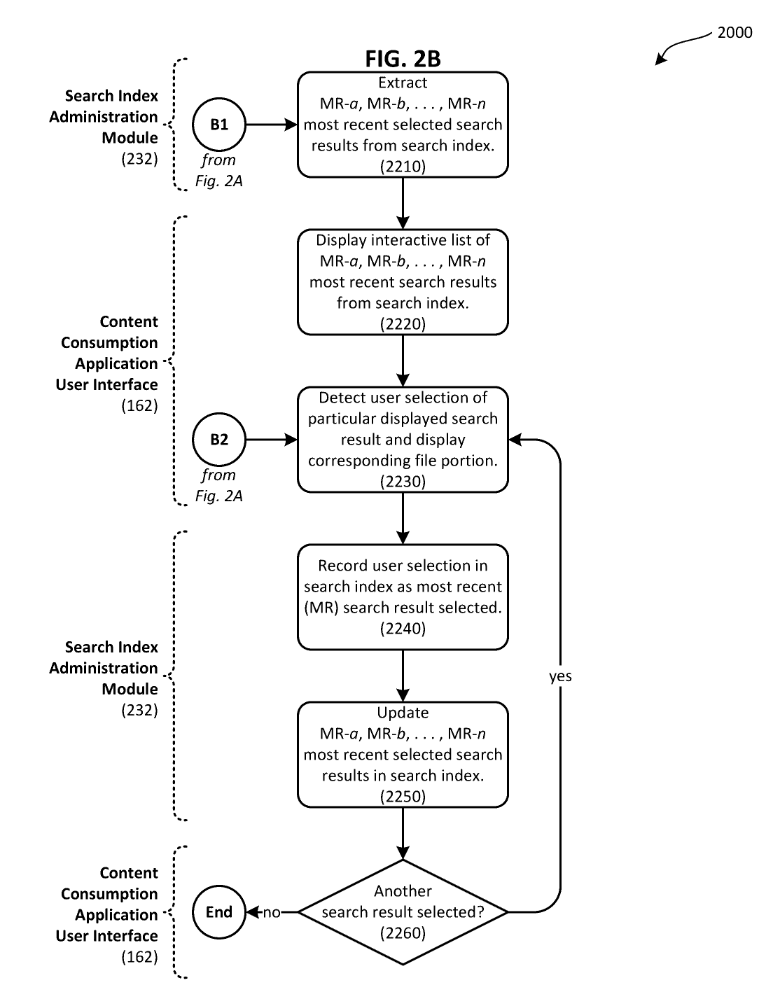

FIGS. 2A and 2B comprise a flowchart illustrating an example method 2000 of caching a user's interactions with a listing of search results. As can be seen, method 2000 includes a number of phases and sub-processes, the sequence of which may vary from one embodiment to another. However, when considered in the aggregate, these phases and sub-processes form part of an improved electronic search framework that is capable of caching a user's interactions with a listing of search results. This search framework is responsive to user input in accordance with certain of the embodiments disclosed herein. Method 2000 can be implemented, for example, using the system architecture illustrated in FIG. 1 and described herein. However other system architectures can be used in other embodiments, as will be apparent in light of this disclosure. To this end, the correlation of the various functionalities shown in FIGS. 2A and 2B to the specific components illustrated in FIG. 1 is not intended to imply any structural and/or use limitations. Rather other embodiments may include, for example, varying degrees of integration wherein multiple functionalities are effectively performed by one system or module. For example in an alternative embodiment a single administration module can be used to administer both cloud storage 220 and search index 230. Thus other embodiments may have fewer or more modules depending on the granularity of implementation. Numerous variations and alternative configurations will be apparent in light of this disclosure.

As illustrated in FIG. 2A, method 2000 commences with using a cloud storage administration process that is invoked by cloud storage administration module 222 to authenticate a user of content consumption application 160. See reference numeral 2110 in FIG. 2A. This can be accomplished using any suitable authentication framework, which may involve, for example, requiring the user to submit an authenticable access token, digital certificate, username, and/or password. In many cases, the user will invoke the cloud storage administration process to authenticate himself/herself so as to gain access to one or more files or other digital resources that are stored in cloud storage 220. In some cases an authentication user interface is provided by content consumption application 160 itself. However, in other cases the authentication user interface is remotely provisioned, such as in an implementation where it is generated by a cloud storage administration process and served to a web browser running on desktop computer 100. Once the user establishes an authenticated session with cloud storage gateway 200, the user can access data stored in cloud storage 220, regardless of the particular client device used to gain such access.

A file is opened with user interface 162 provided by content consumption application 160. See reference numeral 2120 in FIG. 2A. User interface 162 also allows a search query to be received. See reference numeral 2140 in FIG. 2A. The search query can be received, for example, in response to the user executing a “Find” or “Search” command. In response to receiving the search query, search function 164 provided by content consumption application 160 compiles a list of search results in the previously opened file. See reference numeral 2150 in FIG. 2A. The list of search results can be compiled using any suitable algorithm for searching the content of an electronic file. Once the list of search results is compiled, user interface 162 displays an interactive list of the search results in the opened file. See reference numeral 2160 in FIG. 2A. An interactive list of search results refers to a list that is responsive to user interactions, such as clicking, tapping, or otherwise selecting one of the search result instances displayed in the list. For example, in one implementation selecting one of the listed search result instances causes client consumption application 160 to display a portion of the opened file that contains the selected search result instance.

In certain embodiments a search index administration process that is invoked by search index administration module 232 makes a determination with respect to whether the opened file and the received search query are included in search index 230. See reference numeral 2170 in FIG. 2A. This can be accomplished, for example, by searching search index 230 for the opened file and the received search query. In some cases search index 230 remains in cloud storage 220, in which case the search can be performed by a process that is invoked by search index administration module 232. In alternative embodiments, search index 230 is transmitted to client device, for example when a file is opened, in which case the search is performed by the client device. In either case, a determination is made with respect to whether the received search query has previously been executed on the opened file, and whether search index 230 includes previously selected search result instances associated with such query. This can be accomplished by, for example, matching the opened file and the received search query with a file and search query, respectively, that are listed in search index 230.

In some cases the received search query will have previously been executed on the opened file, and search index 230 will include previously selected search result instances associated with such query. In this case, a search index administration process that is invoked by search index administration module 232 extracts, from search index 230, n most recently selected search result instances associated with the search query. See reference numeral 2210 in FIG. 2B. As noted above, in certain embodiments, these most recently selected search result instances are indicated in a lower level of the hierarchical data structure that comprises search index 230. As with the previously generated interactive list of search results (see reference numeral 2160 in FIG. 2A), these most recently selected search result instances can be displayed in an interactive list in user interface 162 provided by content consumption application 160. See reference numeral 2220 in FIG. 2B. In one implementation, where multiple previously selected search result instances are displayed, the displayed instances are listed in reverse chronological order, for example with the most recently selected instance is displayed first.

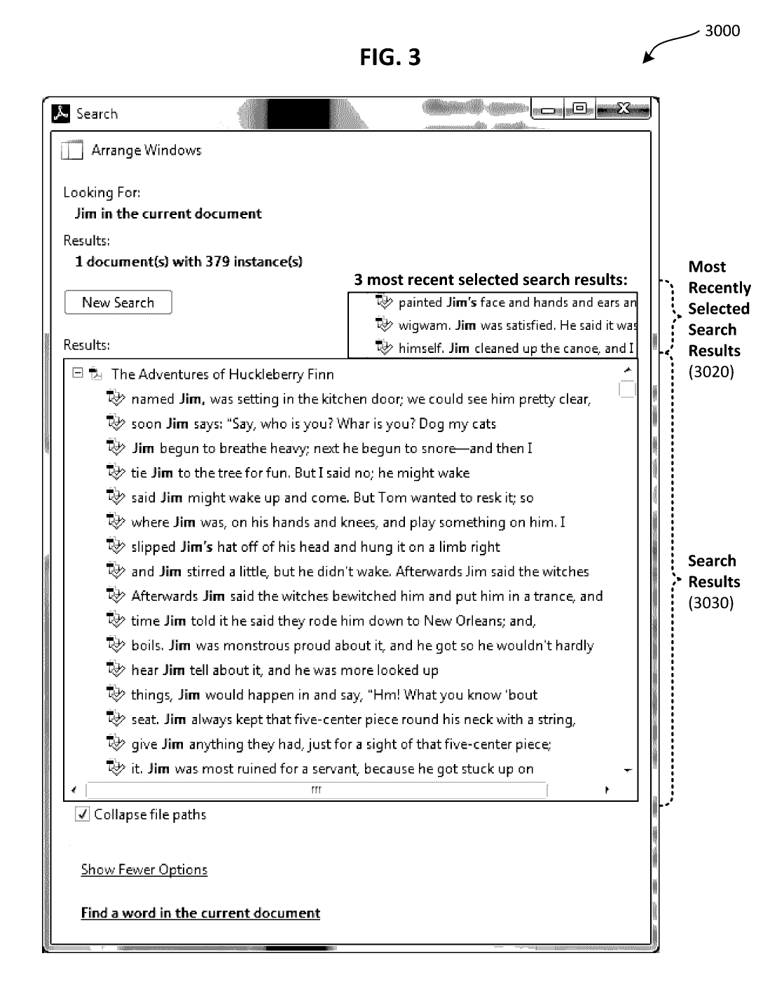

FIG. 3 is a screenshot illustrating an example user interface 3000 that displays both a comprehensive listing of search results 3030, as well as a focused list of most recently selected search results 3020 from amongst those included in the comprehensive listing. The comprehensive list of search results 3030 is generated by executing the search query on the opened file. The focused list of most recently selected search results 3020 is generated by extracting most recently selected search results 3020 from a lower level of the hierarchical data structure that comprise search index 230. The focused list of most recently selected search results 3020 is therefore a list of the n most recently selected search results from amongst those search results included in the comprehensive list. It is referred to herein as a focused list because it focuses on those search results which the user has interacted with most recently. It may or may not be displayed with a distinguishing visual characteristic (for example, color or typeface) or placement (for example, above or beside) as compared to the comprehensive list. User interface 3000 indicates the number of most recently selected search results n which are available to be displayed (in this example, n=3). The focused list of most recently selected search results 3020 is optionally interactive, such that selecting a particular search result instance causes client consumption application 160 to display a portion of the opened file that contains the selected instance. Such interactivity optionally extends to updating search index 230 to reflect most recently selected instances of search results displayed in both the comprehensive and focused listings of search results 3020, 3030.

Because the focused list of most recently selected search results 3020 is generated by extracting data from search index 230, which is stored in cloud storage 220, it will be appreciated that this focused list of search results 3020 is device-independent. In particular, as described above with respect to FIG. 1, search index 230 contains search query results which may have been performed on any of a wide range of devices that the user accesses. Thus, for example, if the user selects a first search result using an office desktop computer, then later selects a second search result using a smartphone while taking the bus home from work, and then even later selects a third search result using a tablet computer while at home, each of these selections will be recorded in cloud-based search index 230. When the user later executes the same query on the same file, perhaps using yet another device, the search query result interaction data can be retrieved from cloud storage and presented to the user in a focused list. In particular, once the user authenticates himself/herself with cloud storage gateway 200, the user is able to access his/her past search query result interaction data when performing subsequent searches.

In some cases the received search query will not have previously been executed on the opened file, or even if such query has been executed, search index 230 will not include previously selected search result instances associated with such query (for example because none of the displayed search results were selected). In this case, no previously selected search result instances will be extracted from search index 230, and only the previously generated interactive list of search results (see reference numeral 2160 in FIG. 2A) is displayed.

Regardless of whether a focused list of most recently selected search results 3020 is displayed, user interface 162 provided by content consumption application 160 can be configured to detect user selection of a particular displayed search result instance, and respond to such selection by displaying a portion of the opened file that contains the selected instance. See reference numeral 2230 in FIG. 2B. Additionally, in response to such selection, a search index administration process that is invoked by search index administration module 232 records the user selection in search index 230 as the most recently selected search result instance for the particular search query and file. See reference numeral 2240 in FIG. 2B. In some cases, updating search index 230 will involve modifying the second-most-recent search result instance, third-most-recent search result instance, and in general n-most-recent search result instances listed in search index 230. See reference numeral 2250 in FIG. 2B. This enables search index 230 to maintain a listing of the n most recently selected search result instances.

For instance, referring again to the specific example illustrated in FIG. 3, the most recently selected search result instance is “ . . . painted Jim's face . . . ”, the second-most-recent search result instance is “ . . . wigwam. Jim was . . . ”, and the third-most-recent search result instance is “ . . . himself. Jim cleaned . . . ”. These three instances are recorded in search index 230 in a hierarchical level under “Search Query ‘Jim’”. If the user were to select another search result instance from amongst the comprehensive listing of search results 3030, say for example “ . . . named Jim, was . . . ”, this new selection would then become the most recently selected search result instance. Search index 230 would be updated accordingly. In particular, what had previously been the most recently selected search result instance (“ . . . painted Jim's face . . . ”) will now be the second-most recent search result instance. And what had previously been the second-most-recent search result instance (“ . . . wigwam. Jim was . . . ”) will now be the third-most recent search result instance. What had previously been the third-most-recent search result instance (“ . . . himself. Jim cleaned . . . ”) is discarded. The selection of a new search result instance can thus be understood as causing the rank of the previously indexed search result instances to be reduced, and causing the nth indexed search result instance to be discarded.

While the list of most recently selected search results 3020 is sorted in reverse chronological order in certain embodiments, other sorting criteria can be used in other embodiments. For instance, examples of alternative sorting criteria that can be used in alternative embodiments include, but are not limited to, alphabetical sorting keyed by text surrounding the selected instance of the keyword, and forward chronological sorting with the most recently selected search result instance at the bottom of the focused list. In another example embodiment, the list of most recently selected search results 3020 is sorted using a location-based order, such that search result instances that are located closest to the current cursor position are positioned near the top of the list. For example, if the current cursor position is on page five, and the most recently selected search result instances are located on pages 1, 7, and 20, then the instance on page 7 will be listed first, followed by the instance on page 1, followed by the instance on page 20. In yet another embodiment, the list of most recently selected search results 3020 is sorted using a counter, wherein search result instances which have been selected more often are positioned near the top of the list. In a modified implementation of this alternative embodiment, only those search result instances which have been selected most frequently are included in the focused list. In this case, the focused list does not include most recently selected search result instances, but most frequently selected search result instances.

In implementations wherein search index 230 remains in cloud storage 220, data characterizing the user's interactions with the search results (“search query result interaction data”) is transmitted from desktop computer 100 to cloud storage 220. Such transmission may occur in real-time, for example immediately after the user selects a particular search result instance, or may occur at a designated time, such as when the opened file is eventually saved or closed. In implementations wherein search index 230 is transmitted to client device, for example when a file is opened, search index 230 can be updated at the client device and returned to cloud storage 220 at a designated time, such as when the opened file is eventually saved or closed. In an alternative embodiment, selection of a particular search result instance causes search index 230 to be updated, but does not necessarily invoke other functionality, such as scrolling to the location of the selected search result instance.

User interface 162 provided by content consumption application 160 can be configured to detect and respond to selection of multiple search result instances. Thus if another displayed search result is selected, either from the list of most recently selected search results 3020 or the comprehensive list of search results 3030, such selection can be detected and responded to as disclosed above. See reference numeral 2260 in FIG. 2B. Thus even where a user selects multiple search result instances in a single session, the n most recently selected instances will continue to be indicated in a lower level of the hierarchical data structure that comprises search index 230. In some implementations, the number n of most recently selected search result instances which are recorded in search index 230 is a user-configurable parameter.

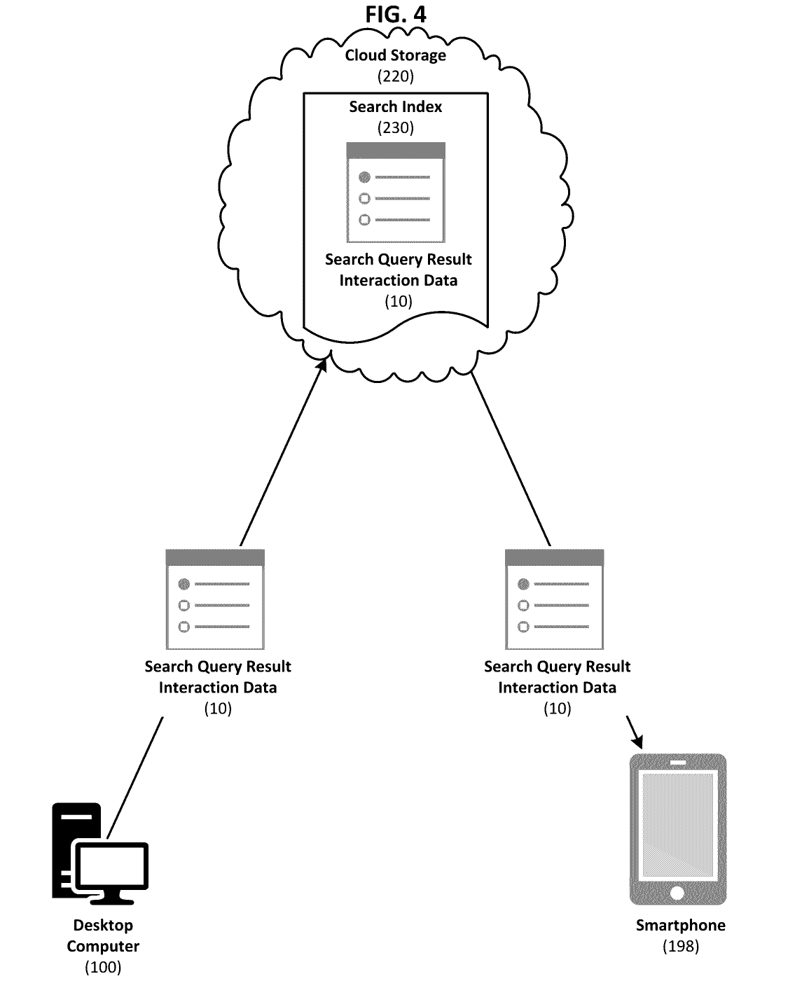

Thus, certain of the embodiments disclosed herein make it easy for a user to maintain a record of his/her interaction history with a particular set of search results, even when the user accesses such interaction history from multiple devices. For example, FIG. 4 is a data flow diagram schematically illustrating the use of cloud storage 220 to facilitate the propagation of search query result interaction data 10 from desktop computer 100 to smartphone 198. Such an implementation allows a user who is reviewing a listing of search results to move from desktop computer 100 to smartphone 198 seamlessly, and in particular, without having to reevaluate search result instances that were already evaluated using desktop computer 100. Search query result interaction data 10 can also be updated based on user interactions which occur at smartphone 198, and can be later propagated back to desktop computer 100, thus enabling the data flow illustrated in FIG. 4 to be reversed. In some cases search query result interaction data 10 comprises updates which are written to, or read from, search index 230 which is maintained in cloud storage 220. In other implementations, search query result interaction data 10 is included within search index 230 which is transmitted from cloud storage 220 to a client device when the client device opens a new file. In this latter embodiment, search index 230 is updated at the client device where the search is executed and the search results are reviewed, and is later transmitted back to cloud storage 220 after the searched file is closed at the client device. Thus it will be appreciated that the various advantages disclosed herein can be realized regardless of whether search index 230 is updated while resident in cloud storage, or while temporarily stored on a particular client device.

### Further Example Embodiments

Numerous variations and configurations will be apparent in light of this disclosure. For instance, one example embodiment provides a computer-implemented search result history management method. The method comprises storing, in a cloud-based storage repository, a search index that is associated with a user and that indicates one or more files and one or more search queries associated with each of the indicated files. Each of the search queries indicated in the search index has associated therewith one or more previously selected search result instances. Each of the previously selected search result instances is associated with a previous interaction between the user and a particular one of the search result instances. The method further comprises receiving, from a client computing device, one or more communications that, collectively, identify a particular file and a particular search query. The method further comprises matching the particular file with one of the files indicated in the search index. The method further comprises matching the particular search query with one of the search queries that is associated with the particular file in the search index. The method further comprises sending, to the client device, the one or more previously selected search result instances associated with the particular search query. In some cases at least one of the one or more communications are received in response to execution of a Find command at the client computing device. In some cases the one or more search queries indicated in the search index represent searches that were previously executed by the user. In some cases the method further comprises (a) receiving, from the client computing device, a second set of one or more communications that, collectively, identify (i) an executed search query that is indicated in the search index, and (ii) a particular search result instance associated with the executed search query; and (b) updating the one or more previously selected search result instances that are associated with the executed search query in the search index; wherein the particular search result instance is indicated as being more recently selected than other previously selected search result instances that are associated with the executed search query. In some cases the one or more communications comprise a first communication that includes a command to open the particular file, and a second communication that identifies the particular search query. In some cases the method further comprises (a) receiving, from the client computing device, a second set of one or more communications that, collectively, identify (i) a new search query that is not indicated in the search index, and (ii) a search result instance associated with the new search query; and (b) updating the search index to include the new search query and the search result instance associated with the new search query as a previously selected search result instance. In some cases the search index has a hierarchical structure in which the one or more files are indicated in a higher level of the hierarchical structure, the one or more search queries are indicated in an intermediate level of the hierarchical structure, and the one or more previously selected search result instances are indicated in a lower level of the hierarchical structure. In some cases the method further comprises authenticating a user of the client computing device, wherein the authenticated user is associated with the search index. In some cases the one or more previously selected search result instances comprise one or more most recently selected search result instances.

Another example embodiment provides a computer program product encoded with instructions that, when executed by one or more processors, cause a search result history management process to be carried out. The search result history management process comprises retrieving a file from a cloud-based storage repository. The file comprises digital content that can be searched according to a particular search query. The process further comprises retrieving a search index from the cloud-based storage repository. The search index indicates one or more search queries associated with the file. Each of the one or more search queries has associated therewith one or more most recently selected search result instances. The process further comprises receiving, via a user interface, a keyword that defines a received search query that is included amongst the one or more search queries indicated in the search index. The process further comprises displaying, in the user interface, a comprehensive listing of search result instances of the keyword within the digital content that comprises the file. The process further comprises extracting, from the search index, the one or more most recently selected search result instances associated with the received search query. The process further comprises displaying, in the user interface, a focused listing of the one or more most recently selected search result instances associated with the received search query. In some cases the search result history management process further comprises submitting, to a cloud storage gateway associated with the cloud-based storage repository, an authentication credential before retrieving the search index from the cloud-based storage repository. In some cases (a) the comprehensive listing of search result instances is displayed in a window with a scrollbar; and (b) actuation of the scrollbar enables additional search result instances included in the comprehensive listing to be displayed. In some cases the search result history management process further comprises (a) receiving a user selection of one of the search result instances collectively displayed in the comprehensive and focused listings; (b) updating, in the search index, the one or more most recently selected search result instances associated with the received query; and (c) sending the updated search index to the cloud-based storage repository. In some cases the search result history management process further comprises (a) receiving, via the user interface, a second keyword that defines a second received search query that is not included amongst the one or more search queries indicated in the search index; (b) displaying, in the user interface, a comprehensive listing of search result instances of the second keyword within the digital content that comprises the file; (c) receiving, via the user interface, a selection of a particular one of the search result instances of the second keyword within the digital content that comprises the file; and (d) updating the search index to include the second received search query and the selection of the particular one of the search result instances of the second keyword in the digital content that comprises the file. In some cases retrieving the file and the search index are performed in response to a command to open the file. In some cases retrieving the file and the search index are performed in response to a command to open the file in an application selected from a group consisting of a word processor, a web browser, and a PDF reader. In some cases the focused listing is displayed above the comprehensive listing.

Another example embodiment provides a search result history management system comprising a memory device and a processor that is operatively coupled to the memory device. The processor is configured to execute instructions stored in the memory device that, when executed, cause the processor to carry out a search result history management process. The search result history management process comprises storing, in a cloud-based storage repository, a search index indicating one or more files and one or more search queries associated with each of the indicated files. Each of the search queries indicated in the search index has associated therewith one or more most recently selected search result instances. The process further comprises receiving, from a client computing device, one or more communications that, collectively, identify a particular file and a particular search query, both of which are also indicated in the search index. The process further comprises sending, to the client device, the one or more most recently selected search result instances associated with the particular search query. In some cases each of the one or more search queries is associated with no more than n most recently selected search result instances, wherein n is a parameter defined by a user of the client computing device. In some cases a plurality of search indices are stored in the cloud-based storage repository, each search index being associated with a different user. In some cases each of the one or more most recently selected search result instances defines a location in a corresponding file where a corresponding search query is found.

The foregoing detailed description has been presented for the purposes of illustration and description. It is not intended to be exhaustive or to limit the disclosure to the particular described embodiments. Therefore many modifications and variations are possible in light of this disclosure. Thus it is intended that the scope of the invention be limited not by this detailed description, but rather by the claims appended hereto.

What is claimed is:

1. A computer-implemented search result history management method comprises:
storing, in a cloud-based storage repository, a search index that is associated with a user and that indicates one or more files and one or more search queries associated with each of the indicated files, wherein each of the search queries indicated in the search index has associated therewith one or more previously selected search result instances, and wherein each of the previously selected search result instances is associated with a previous interaction between the user and a particular one of the search result instances;
receiving, from a client computing device, one or more communications that, collectively, identify a particular file and a particular search query;
matching the particular file with one of the files indicated in the search index;
matching the particular search query with one of the search queries that is associated with the particular file in the search index;
sending, to the client device, the one or more previously selected search result instances associated with the particular search query.

2. The method of claim 1, wherein at least one of the one or more communications are received in response to execution of a Find command at the client computing device.

3. The method of claim 1, wherein the one or more previously selected search result instances comprise one or more most recently selected search result instances.

4. The method of claim 1, further comprising:
receiving, from the client computing device, a second set of one or more communications that, collectively, identify (a) an executed search query that is indicated in the search index, and (b) a particular search result instance associated with the executed search query; and
updating the one or more previously selected search result instances that are associated with the executed search query in the search index;
wherein the particular search result instance is indicated as being more recently selected than other previously selected search result instances that are associated with the executed search query.

5. The method of claim 1, wherein the one or more communications comprise a first communication that includes a command to open the particular file, and a second communication that identifies the particular search query.

6. The method of claim 1, further comprising:
receiving, from the client computing device, a second set of one or more communications that, collectively, identify (a) a new search query that is not indicated in the search index, and (b) a search result instance associated with the new search query; and
updating the search index to include the new search query and the search result instance associated with the new search query as a previously selected search result instance.

7. The method of claim 1, wherein the search index has a hierarchical structure in which the one or more files are indicated in a higher level of the hierarchical structure, the one or more search queries are indicated in an intermediate level of the hierarchical structure, and the one or more previously selected search result instances are indicated in a lower level of the hierarchical structure.

8. The method of claim 1, further comprising authenticating a user of the client computing device, wherein the authenticated user is associated with the search index.

9. A computer program product encoded with instructions that, when executed by one or more processors, cause a search result history management process to be carried out, the search result history management process comprising:
retrieving a file from a cloud-based storage repository, the file comprising digital content that can be searched according to a particular search query;
retrieving a search index from the cloud-based storage repository, the search index indicating one or more search queries associated with the file, wherein each of the one or more search queries has associated therewith one or more most recently selected search result instances;
receiving, via a user interface, a keyword that defines a received search query that is included amongst the one or more search queries indicated in the search index;
displaying, in the user interface, a comprehensive listing of search result instances of the keyword within the digital content that comprises the file;
extracting, from the search index, the one or more most recently selected search result instances associated with the received search query; and
displaying, in the user interface, a focused listing of the one or more most recently selected search result instances associated with the received search query.

10. The computer program product of claim 9, wherein the search result history management process further comprises submitting, to a cloud storage gateway associated with the cloud-based storage repository, an authentication credential before retrieving the search index from the cloud-based storage repository.

11. The computer program product of claim 9, wherein:
the comprehensive listing of search result instances is displayed in a window with a scrollbar; and
actuation of the scrollbar enables additional search result instances included in the comprehensive listing to be displayed.

12. The computer program product of claim 9, wherein the search result history management process further comprises:
receiving a user selection of one of the search result instances collectively displayed in the comprehensive and focused listings;
updating, in the search index, the one or more most recently selected search result instances associated with the received query; and
sending the updated search index to the cloud-based storage repository.

13. The computer program product of claim 9, wherein the search result history management process further comprises:
receiving, via the user interface, a second keyword that defines a second received search query that is not included amongst the one or more search queries indicated in the search index;
displaying, in the user interface, a comprehensive listing of search result instances of the second keyword within the digital content that comprises the file;
receiving, via the user interface, a selection of a particular one of the search result instances of the second keyword within the digital content that comprises the file; and
updating the search index to include the second received search query and the selection of the particular one of the search result instances of the second keyword in the digital content that comprises the file.

14. The computer program product of claim 9, wherein retrieving the file and the search index are performed in response to a command to open the file.

15. The computer program product of claim 9, wherein retrieving the file and the search index are performed in response to a command to open the file in an application selected from a group consisting of a word processor, a web browser, and a portable document format (PDF) reader.

16. The computer program product of claim 9, wherein the focused listing is displayed above the comprehensive listing.

17. A search result history management system comprising a memory device and a processor that is operatively coupled to the memory device, wherein the processor is configured to execute instructions stored in the memory device that, when executed, cause the processor to carry out a search result history management process that comprises:
storing, in a cloud-based storage repository, a search index indicating one or more files and one or more search queries associated with each of the indicated files, wherein each of the search queries indicated in the search index has associated therewith one or more most recently selected search result instances;
receiving, from a client computing device, one or more communications that, collectively, identify a particular file and a particular search query, both of which are also indicated in the search index; and
sending, to the client device, the one or more most recently selected search result instances associated with the particular search query.

18. The search result history management system of claim 17, wherein each of the one or more search queries is associated with no more than n most recently selected search result instances, wherein n is a parameter defined by a user of the client computing device.

19. The search result history management system of claim 17, wherein a plurality of search indices are stored in the cloud-based storage repository, each search index being associated with a different user.

20. The search result history management system of claim 17, wherein each of the one or more most recently selected search result instances defines a location in a corresponding file where a corresponding search query is found.
